(19) United States
(12) Patent Application Publication
(10) Pub. No.: US 2023/0381759 A1
(43) Pub. Date: Nov. 30, 2023

(54) MOLECULAR SIEVE BORON SSZ-121, ITS SYNTHESIS AND USE

(71) Applicant: Chevron U.S.A. Inc., San Ramon, CA (US)

(72) Inventors: Stacey I. Zones, San Francisco, CA (US); Cong-Yan Chen, Kensington, CA (US)

(73) Assignee: Chevron U.S.A. Inc., San Ramon, CA (US)

(21) Appl. No.: 18/325,211

(22) Filed: May 30, 2023

Related U.S. Application Data
(60) Provisional application No. 63/365,542, filed on May 31, 2022.

(51) Int. Cl. B01J 29/86; C01B 37/00; B01J 27/045; B01J 37/04; B01J 37/00; B01J 37/03; C01B 3/40

(52) U.S. Cl. CPC B01J 29/86; C01B 37/005; B01J 27/045; B01J 37/04; B01J 37/0018; B01J 37/031; C01B 3/40; C01P 2002/72; C01B 2203/0227; C01B 2203/107; C01B 2203/1082

(57) ABSTRACT

A novel synthetic crystalline molecular sieve material, designated boron SSZ-121 is provided. The boron SSZ-121 can be synthesized using 1,3-bis(1-adamantyl)imidazolium cations as a structure directing agent. The boron SSZ-121 may be used in organic compound conversion reactions and/or sorptive processes.

### CROSS REFERENCE TO RELATED APPLICATIONS

The present application claims priority to U.S. Provisional Application No. 63/365,542, filed May 31, 2022, the complete disclosure of which is incorporated herein by reference in its entirety

### FIELD

This disclosure relates to a novel synthetic crystalline germanosilicate molecular sieve designated boron SSZ-121, and its synthesis.

### BACKGROUND

Molecular sieves are a commercially important class of materials that have distinct crystal structures with defined pore structures that are shown by distinct X-ray diffraction (XRD) patterns. The molecular sieves also have specific chemical compositions. The crystal structure defines cavities and pores that are characteristic of the specific type of molecular sieve. Providing new molecular sieves that offer differences in the crystal structure as well as the composition can lead to unique catalysts or adsorption/separation materials. Changing a crystal structure is always fraught with difficulties, but success can provide rewards in a new catalyst for organic compound conversion reactions. U.S. Pat. No. 11,161,750 discloses the preparation of SSZ-121. It does not, however, disclose a boron SSZ-121.

### SUMMARY

According to the present disclosure, a new crystalline germanosilicate molecular sieve, designated boron SSZ-121 is synthesized using 1,3-bis(1-adamantyl)imidazolium cations as a structure directing agent (SDA). The synthesis has been found to be successful in providing a boron containing molecular sieve having the SSZ-121 crystal structure.

In one aspect, there is provided a boron SSZ-121 molecular sieve having in its as-synthesized form a powder X-ray diffraction pattern with at least the following 2-theta scattering angles: 6.3±0.2, 7.0±0.2, 9.5±0.2, 13.0±0.2, 16.0±0.2, 18.5±0.2, 19.8±0.2, 21.2±0.2, 24.0±0.2, 25.0±0.2, 26.5±0.2, 28.5±0.2 and 30.0±0.2 degrees 2-theta.

In its as-synthesized and anhydrous form, the boron SSZ-121 molecular sieve can have a chemical composition comprising the following molar relationship:

TABLE 1

| | Broadest | Secondary |
|---|---|---|
| (SiO₂ + GeO₂)/B₂O₃ | ≥10 | ≥15 |
| Q/(SiO₂ + GeO₂) | >0 to 0.1 | >0 to 0.1 |
| Q/SiO₂ | ≤0.1 | ≤0.05 |

wherein Q comprises 1,3-bis(1-adamantyl)imidazolium cations.

In a second aspect, there is provided a SSZ-121 molecular sieve comprising boron having, in its calcined form, a powder XRD pattern with at least the following 2-theta scattering angles: 6.5±0.2, 9.5±0.2, 13.0±0.2, 18.5±0.2, 19.8±0.2, 21.2±0.2, 24.0±0.2, 25.0±0.2, 26.5±0.2, 28.5±0.2 and 30.0±0.2 degrees 2-theta.

In its calcined form, the boron SSZ-121 molecular sieve comprising boron can have a chemical composition comprising the following molar relationship:

B₂O₃:(n)(SiO₂+GeO₂)

wherein n is ≥10.

In a further aspect, there is provided a method of synthesizing the molecular sieve described herein, the method comprising (1) preparing a reaction mixture comprising: (a) a FAU framework type zeolite; (b) a source of germanium; (c) a source of boron; (d) a structure directing agent comprising 1,3-bis(1-adamantyl)imidazolium cations (Q); (e) a source of fluoride ions; and (f) water; and (2) subjecting the reaction mixture to crystallization conditions sufficient to form crystals of the boron molecular sieve. The boron containing SSZ-121 molecular sieve is then treated to remove the SDA, which can be achieved by calcination or by ozone treatment.

In yet another aspect, there is provided a process of converting a feedstock comprising an organic compound to a conversion product which comprises contacting the feedstock at organic compound conversion conditions with a catalyst comprising the boron SSZ-121 molecular sieve described herein.

Among other factors, the present process allows one to obtain a boron SSZ-121 molecular sieve, which is a boron germanosilicate. This new molecular sieve prepared by the present process can offer unique abilities as a catalyst in organic compound conversion reactions. The molecular sieve also finds important value as an adsorption/separation material.

### DETAILED DESCRIPTION

### Definitions

The term “framework type” has the meaning described in the “Atlas of Zeolite Framework Types” by Ch. Baerlocher, L. B. McCusker and D. H. Olsen (Elsevier, Sixth Revised Edition, 2007).

The term “borongermanosilicate” refers to a crystalline microporous solid including boron, germanium and silicon oxides within its framework structure. The borongermanosilicate may be a “pure-borongermanosilicate” (i.e., absent other detectable metal oxides with its framework structure) or optionally substituted. When described as “optionally substituted,” the respective framework may contain other atoms (e.g., Al, Ga, In, Fe, Ti, Zr) substituted for one or more of the atoms not already present in the parent framework.

The term “as-synthesized” is employed herein to refer to a molecular sieve in its form after crystallization, prior to removal of the structure directing agent.

The term “anhydrous” is employed herein to refer to a molecular sieve substantially devoid of both physically adsorbed and chemically adsorbed water.

As used herein, the numbering scheme for the Periodic Table Groups is as disclosed in Chem. Eng. News 1985, 63(5), 26-27.

### Synthesis of the Molecular Sieve

The present molecular sieve boron SSZ-121 can be synthesized by: (1) preparing a reaction mixture comprising (a) a FAU framework type zeolite; (b) a source of germanium; (c) a source of boron; (d) a structure directing agent comprising 1,3-bis(1-adamantyl)imidazolium cations (Q); (e) a source of fluoride ions; and (f) water; then (2) subjecting the reaction mixture to crystallization conditions sufficient to form crystals of a boron SSZ-121 molecular sieve. If aluminum is present, it is only present in a small amount. Thus, the framework contains a predominant amount of boron. The ratio of SiO₂/Al₂O₃ can be 300 or greater.

The reaction mixture can have a composition, in terms of molar ratios, within the ranges set forth in Table 2:

TABLE 2

| Reactants | Broadest | Secondary |
|---|---|---|
| (SiO₂ + GeO₂)/B₂O₃ | ≥10 | ≥15 |
| Q/(SiO₂ + GeO₂) | 0.10 to 1.00 | 0.20 to 0.70 |
| F/(SiO₂ + GeO₂) | 0.10 to 1.00 | 0.20 to 0.70 |
| H₂O/(SiO₂ + GeO₂) | 2 to 10 | 4 to 8 |
| SiO₂/GeO₂ | 4 to 12 | 6 to 10 |
| SiO₂/B₂O₃ | ≥10 | |

wherein Q comprises 1,3-bis(1-adamantyl)imidazolium cations. In one embodiment, the molar ratio of (SiO₂+GeO₂)/B₂O₃ is in the range of 15 to 20.

Suitable sources of silicon oxide can include any suitable known source such as colloidal silica, fumed silica, precipitated silica, or alkali metal silicates. A FAU framework type zeolite, e.g., zeolite Y, can also be a source of silicon oxide. In such a case, the FAU framework type zeolite can be an ammonium-form zeolite or a hydrogen-form zeolite and is a source of silica for the reaction. The FAU zeolite will generally have a SiO₂/Al₂O₃ molar ratio of at least 300 or more. Examples of the FAU framework type zeolite include zeolite Y (e.g., HSZ-HUA390). Zeolite Y can have a SiO₂/Al₂O₃ molar ratio of from 300 to 500. The FAU framework type zeolite can comprise two or more zeolites. The two or more zeolites can be Y zeolites having different silica-to-alumina molar ratios. The FAU framework type zeolite can be the sole or predominant source of silicon. In some aspects, a separate source of silicon may be added. Separate sources of silicon include colloidal silica, fumed silica, precipitated silica, alkali metal silicates and tetraalkyl orthosilicates.

Suitable sources of germanium include germanium oxide and germanium alkoxides (e.g., germanium ethoxide, germanium isopropoxide).

Silicon and germanium may be present in the reaction mixture in a SiO₂/GeO₂ molar ratio of from 4 to 12 (e.g., 6 to 10).

Suitable sources of boron can include boric acid, which is preferred.

Suitable sources of fluoride ions include hydrogen fluoride, ammonium fluoride and ammonium bifluoride.

The structure directing agent comprises 1,3-bis(1-adamantyl)imidazolium cations (Q), represented by the following structure (1):

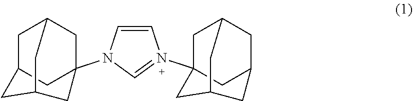

Suitable sources of Q are the hydroxides, chlorides, bromides, and/or other salts of the quaternary ammonium compound.

The reaction mixture can have a Q/F molar ratio in a range of from 0.80 to 1.20 (e.g., 0.85 to 1.15, 0.90 to 1.10, 0.95 to 1.05, or 1 to 1).

The reaction mixture can contain seeds of a molecular sieve material, such as boron SSZ-121 from a previous synthesis, in an amount of from 0.01 to 10,000 ppm by weight (e.g., 100 to 5000 ppm by weight) of the reaction mixture. Seeding can be advantageous in decreasing the amount of time necessary for complete crystallization to occur. In addition, seeding can lead to an increased purity of the product obtained by promoting the nucleation and/or formation of boron SSZ-121 over any undesired phases.

It is noted that the reaction mixture components can be supplied by more than one source. Also, two or more reaction components can be provided by one source. The reaction mixture can be prepared either batchwise or continuously.

### Crystallization and Post-Synthesis Treatment

Crystallization of the boron SSZ-121 molecular sieve from the above reaction mixture can be carried out under either static, tumbled or stirred conditions in a suitable reactor vessel (e.g., a polypropylene jar or a Teflon-lined or stainless-steel autoclave) at a temperature of from 100° C. to 200° C. (e.g., 150° C. to 175° C.) for a time sufficient for crystallization to occur at the temperature used (e.g., 1 day to 14 days, or 2 days to 10 days). The hydrothermal crystallization process is typically conducted under pressure, such as in an autoclave, and is preferably under autogenous pressure.

Once the molecular sieve crystals have formed, the solid product can be recovered from the reaction mixture by standard mechanical separation techniques such as centrifugation or filtration. The recovered crystals are water-washed and then dried to obtain the as-synthesized molecular sieve crystals. The drying step can be performed at an elevated temperature (e.g., 75° C. to 150° C.) for several hours (e.g., about 4 to 24 hours). The drying step can be performed under vacuum or at atmospheric pressure.

As a result of the crystallization process, the recovered crystalline molecular sieve product contains within its pore structure at least a portion of the structure directing agent used in the synthesis.

The as-synthesized molecular sieve may also be subjected to treatment to remove part or all of the structure directing agent used in its synthesis. This is conveniently effected by thermal treatment (i.e., calcination) in which the as-synthesized material is heated at a temperature of at least about 370° C. for at least 1 minute and generally not longer than 20 hours. While sub-atmospheric pressure can be employed for the thermal treatment, atmospheric pressure is desired for reasons of convenience. The thermal treatment can be performed at a temperature up to about 925° C. The thermal treatment may be carried out in an atmosphere selected from air, nitrogen or mixture thereof. For example, the thermal treatment may be conducted at a temperature of from 400° C. to 600° C. in air for a time period of from 3 to 8 hours. Alternatively, the structure directing agent Q can be removed by treatment with ozone. The ozone treatment may include heating the as-synthesized molecular sieve in the presence of ozone, such heating may be at a temperature of from 50° C. to 350° C. (e.g., from 100° C. to 300° C., or from 125° C. to 250° C.). It has also been found that the SDA can be removed by treatment with dimethyl formamide, e.g., treatment at about 150° C.

### Characterization of the Molecular Sieve

In its as-synthesized and anhydrous form, molecular sieve SSZ-121 with boron can have a chemical composition comprising the following molar relationship set forth in Table 1:

TABLE 1

| | Broadest | Secondary |
|---|---|---|
| (SiO₂ + GeO₂)/B₂O₃ | ≥10 | ≥15 |
| Q/(SiO₂ + GeO₂) | >0 to 0.1 | >0 to 0.1 |
| Q/SiO₂ | ≤0.1 | ≤0.05 |

wherein Q comprises 1,3-bis(1-adamantyl)imidazolium cations. In some aspects, the molecular sieve can have a SiO₂/GeO₂ molar ratio in a range of from 4 to 12 (e.g., from 6 to 10). In one embodiment, the (SiO₂+GeO₂)/B₂O₃ molar ratio ranges from 15 to 20.

In its calcined form, molecular sieve SSZ-121 with boron can have a chemical composition comprising the following molar relationship:

B₂O₃:(n)(SiO₂+GeO₂)

wherein n is ≥10 (e.g., 10 to 30, 15 to 30, and 15 to 20).

It should be noted that the as-synthesized form of the present boron SSZ-121 molecular sieve may have molar ratios different from the molar ratios of reactants of the reaction mixture used to prepare the as-synthesized form. This result may occur due to incomplete incorporation of 100% of the reactants of the reaction mixture into the crystals formed (from the reaction mixture).

In its as-synthesized form, the boron molecular sieve SSZ-121 exhibits a powder XRD pattern with at least the following 2-theta scattering angles: 6.3±0.2, 7.0±0.2, 9.5±0.2, 13.0±0.2, 16.0±0.2, 18.5±0.2, 19.8±0.2, 21.2±0.2, 24.0±0.2, 25.0±0.2, 26.5±0.2, 28.5±0.2 and 30.0±0.2 degrees 2-theta. In its calcined form, molecular sieve SSZ-121 with boron exhibits a powder XRD pattern with at least the following 2-theta scattering angles: 6.5±0.2, 9.5±0.2, 13.0±0.2, 18.5±0.2, 19.8±0.2, 21.2±0.2, 24.0±0.2, 25.0±0.2, 26.5±0.2, 28.5±0.2 and 30.0±0.2 degrees 2-theta.

The powder X-ray diffraction patterns presented herein were collected by standard techniques. The radiation was CuKα radiation. The peak heights and the positions, as a function of 2θ where θ is the Bragg angle, were read from the relative intensities of the peaks (adjusting for background), and d, the interplanar spacing corresponding to the recorded lines, can be calculated.

Minor variations in the diffraction pattern can result from variations in the mole ratios of the framework species of the sample due to changes in lattice constants. In addition, disordered materials and/or sufficiently small crystals will affect the shape and intensity of peaks, leading to significant peak broadening. Minor variations in the diffraction pattern can also result from variations in the organic compound used in the preparation. Calcination can also cause minor shifts in the XRD pattern. Notwithstanding these minor perturbations, the basic crystal lattice structure remains unchanged.

### INDUSTRIAL APPLICABILITY

Molecular sieve boron SSZ-121 (where part or all of the structure directing agent is removed) may be used as a sorbent or as a catalyst to catalyze a wide variety of organic compound conversion processes. Of particular applicability is use of the boron SSZ-121 in reforming processes.

Catalytic reforming is one of the basic petroleum refining processes for upgrading light hydrocarbon feedstocks, frequently referred to as naphtha feedstocks. Products from catalytic reforming can include high octane gasoline useful as automobile fuel, aromatics (for example benzene, toluene, xylenes and ethylbenzene), and/or hydrogen. Reactions typically involved in catalytic reforming include dehydrocylization, isomerization and dehydrogenation of naphtha range hydrocarbons, with dehydrocyclization and dehydrogenation of linear and slightly branched alkanes and dehydrogenation of cycloparaffins leading to the production of aromatics. Dealkylation and hydrocracking are generally undesirable due to the low value of the resulting light hydrocarbon products.

The boron SSZ-121 catalyst used in reforming reactions would often include a Group VIII metal, such as platinum or palladium, or a Group VIII metal plus a second catalytic metal, which acts as a promoter. Examples of metals useful as promoters include rhenium, tin, tungsten, germanium, cobalt, nickel, rhodium, ruthenium, iridium or combinations thereof. The catalytic metal or metals may be dispersed on a support such as alumina, silica, or silica-alumina.

The boron SSZ-121 reforming catalyst may be employed in the form of pills, pellets, granules, broken fragments, or various special shapes, disposed as a fixed bed within a reaction zone, and the charging stock may be passed through in the liquid, vapor, or mixed phase, and in either upward, downward or radial flow. Alternatively, the reforming catalysts can be used in moving beds or in fluidized-solid processes, in which the charging stock is passed upward through a turbulent bed of finely divided catalyst. However, a fixed bed system or a dense-phase moving bed system are preferred due to less catalyst attrition and other operational advantages. In a fixed bed system, the feed is preheated (by any suitable heating means) to the desired reaction temperature and then passed into a reaction zone containing a fixed bed of the catalyst. This reaction zone may be one or more separate reactors with suitable means to maintain the desired temperature at the reactor entrance. The temperature must be maintained because reforming reactions are typically endothermic in nature.

The actual reforming conditions often depend, at least in part, on the feed used, whether highly aromatic, paraffinic or naphthenic and upon the desired octane rating of the product and the desired hydrogen production.

### EXAMPLES

The following illustrative examples are intended to be non-limiting.

### Example 1

### Synthesis of SSZ-121 Boron

Into a tared cup 42.5 grams of a solution of the SDA is added as OH, which is 0.28 Molar. Then into the solution is added (a) 1.20 grams of Tosoh HUA 390 FAU zeolite with SAR=500, (b) 0.225 grams of Germanium dioxide (c) 0.06 grams of boric acid. Then the open tared cup is set to evaporate in a hood until the H₂O/TO₂ ratio comes down to 7. The reaction is then given HF in an amount equal to the amount of SDA mmoles. Then the contents of the cup are moved into a 23 ml Teflon cup for a Parr stainless steel reactor which is closed and loaded onto a rotating spit (43 RPM) in a convection heated oven. The crystallization is carried out over about 15 days at 160° C. (it may be advantages to seed the zeolite synthesis using typically about 3 wt % of the Tosoh reagent used). The product is collected and washed 4 times, 50 ml H₂O each aliquot.

The recovered product can then be treated to remove SDA.

### Example 2

### Calcination of SSZ-121 Boron

The as-synthesized molecular sieve of Example 1 can be calcined inside a muffle furnace under a flow of air heated to 550° C. at a rate of 1° C./minute and held at 550° C. for 5 hours, cooled and then analyzed by powder XRD. The XRD pattern confirmed the product was boron SSZ-121.

### Example 3

While one can calcine the Boron SSZ-121, it is preferred to first treat the zeolite with ozone at 150° C. to remove the SDA guest molecule. In addition, it was also found that much of the SDA could be first removed by a treatment with dimethylformide in a closed reactor at 150° C.; 1 grams of as-made zeolite and 7 ml dimethylformamide, heated static for 3-5 days.

The as-made boron SSZ-121 can be loaded into a cell to then have ozone passed through it while heated to 150° C. The treatment is carried out for 16-20 hours. The mass loss (if not treated by dimethylformamide) can be roughly 40%.

The XRD pattern can be essentially the same as the calcined XRD pattern described previously.

### Example 4

### Characterization by Argon Uptake

The boron SSZ-121 prepared in Example 1 was subjected to ozonolysis to remove the SDA. The ozonolysis procedure was that described in Example 3.

After the ozonolysis, adsorption of argon gas at 87K was measured, and the results relating to zeolite characterization were as follows:

| Total pore | MBET surface | t-plot micropore | Mesopore volume |
|---|---|---|---|
| volume (cc/g) | area (m²/g) | volume (cc/g) | (cc/g) |
| 1.056 | 720.6 | 0.235 | 0.763 |

The characterization of the boron SSZ-121 provides indications of good catalytic activity.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise that as specifically described without actually departing from the spirit and scope of the present invention as defined by the appended claims.

1. A molecular sieve having a powder X-ray diffraction pattern with at least the following 2-theta scattering angles: 6.5±0.2, 9.5±0.2, 13.0±0.2, 18.5±0.2, 19.8±0.2, 21.2±0.2, 24.0±0.2, 25.0±0.2, 26.5±0.2, 28.5±0.2 and 30.0±0.2 degrees 2-theta; the molecular sieve comprising boron in the framework.

2. The molecular sieve of claim 1, having a composition comprising the molar relationship:
B₂O₃:(n)(SiO₂+GeO₂)
wherein n is ≥10.

3. The molecular sieve of claim 1, having a composition comprising the molar relationship:
B₂O₃:(n)(SiO₂+GeO₂)
wherein n is ≥15.

4. A molecular sieve having, in its as-synthesized form, a powder X-ray diffraction pattern with at least the following 2-theta scattering angles: 6.3±0.2, 7.0±0.2, 9.5±0.2, 13.0±0.2, 16.0±0.2, 18.5±0.2, 19.8±0.2, 21.2±0.2, 24±0.2, 25.0±0.2, 26.5±0.2, 28.5±0.2 and 30.0±0.2 degrees 2-θ, and with the molecular sieve comprising boron in the framework.

5. The molecular sieve of claim 4, having a chemical composition comprising the following molar relationship:

| | |
|---|---|
| (SiO₂ + GeO₂)/B₂O₃ | ≥10 |
| Q/(SiO₂ + GeO₂) | >0 to 0.1 |

wherein Q comprises 1,3-bis(1-adamantyl)imidazolium cations.

6. The molecular sieve of claim 4, having a chemical composition comprising the following molar relationship:

| | |
|---|---|
| (SiO₂ + GeO₂)/B₂O₃ | ≥15 |
| Q/(SiO₂ + GeO₂) | >0 to 0.1 |

wherein Q comprises 1,3-bis(1-adamantyl)imidazolium cations.

7. The molecular sieve of claim 2, which is sulfided and comprises a Group VIII metal.

8. The molecular sieve of claim 7, wherein the Group VIII metal is platinum or palladium.

9. A method of synthesizing the molecular sieve of claim 4, the method comprising:
(1) preparing a reaction mixture comprising:
(a) a FAU framework type zeolite having a SiO₂/Al₂O₃ molar ratio of 300 or greater;
(b) a source of germanium;
(c) a source of boron;
(d) a structure directing agent comprising 1,3-bis(1-adamantyl)imidazolium cations (Q);
(e) a source of fluoride ions; and
(f) water; and
(2) subjecting the reaction mixture to crystallization conditions sufficient to form crystals of the molecular sieve.

10. The method of claim 9, wherein the reaction mixture has a composition, in terms of molar ratios, as follows:

| | |
|---|---|
| (SiO₂ + GeO₂)/B₂O₃ | ≥10 |
| Q/(SiO₂ + GeO₂) | 0.10 to 1.00 |
| F/(SiO₂ + GeO₂) | 0.10 to 1.00 |
| H₂O/(SiO₂ + GeO₂) | 2 to 10. |

11. The method of claim 9, wherein the reaction mixture has a composition, in terms of molar ratios, as follows:

| | |
|---|---|
| (SiO₂ + GeO₂)/B₂O₃ | ≥15 |
| Q/(SiO₂ + GeO₂) | 0.20 to 0.70 |
| F/(SiO₂ + GeO₂) | 0.20 to 0.70 |
| H₂O/(SiO₂ + GeO₂) | 4 to 8. |

12. The method of claim 9, wherein the FAU framework type zeolite is zeolite Y having a SiO₂/Al₂O₃ molar ratio of 300 or greater.

13. The method of claim 9, wherein the crystallization conditions include a temperature of from 100° C. to 200° C.

14. The method of claim 9, wherein the reaction mixture has a molar ratio of Q/F in a range of from 0.8 to 1.2.

15. A process for converting a feedstock comprising an organic compound to a conversion product, the process comprising contacting the feedstock at organic compound conversion conditions with a catalyst comprising the molecular sieve of claim 7.

16. The process of claim 15, wherein the reaction is a reforming reaction and the catalyst comprises platinum.

17. A molecular sieve prepared by the process of claim 9.
